(19) United States
(12) Patent Application Publication
(10) Pub. No.: US 2025/0174974 A1
(43) Pub. Date: May 29, 2025

(54) WIRE HARNESS CLAMPING SYSTEM

(71) Applicant: VALEO VISION, Bobigny (FR)

(72) Inventor: Brian HUNT, Seymour, IN (US)

(73) Assignee: VALEO VISION, Bobigny (FR)

(21) Appl. No.: 18/522,609

(22) Filed: Nov. 29, 2023

(51) Int. Cl. H02G 3/32; B60R 16/02

(52) U.S. Cl. CPC H02G 3/32; B60R 16/0215

(57) ABSTRACT

The present invention relates to a wire harness clamping system. The system includes at least one rib extending from a housing surface that forms a space within. A plug with a cable tie is received in the space formed by the rib(s), and the cable tie is wound around the wire harness, to grip the harness firmly. Moreover, in another embodiment, the wiring harness may be positioned directly in the space formed by the ribs and a cap may be locked over the ribs to secure the harness within. The ribs and the cap may be formed to any shape such as circular, rectangular, S-shaped etc. design, as is suitable.

### TECHNICAL FIELD

The present invention relates to a wire harness clamping system, and more particularly to a system for clamping wire harness on a housing of a lighting device.

### BACKGROUND OF THE INVENTION

Lighting devices are being used in motor vehicles to perform various functions such as head light, tail light, turn indication, corner light, fog light etc. These lighting devices comprise light source(s), which are connected to a vehicle electrical system by wire or cable for supplying electrical power to the lamps. Furthermore, wires are required to connect one or more printed circuit board(s) to a vehicle control unit. Wire harnesses may include the wires that are used for different numerous applications in the vehicle.

These wire harnesses are required to be securely clamped in their desired positions in order to prevent problems during the assembly and disassembly of lighting devices. Moreover, the wire harnesses may be liable to be damaged due to various forces experienced during use. Furthermore, failure to maintain the wire harness in the desired position may prevent the lamp from rotating or aiming properly during the aiming process.

Various mounting arrangements are provided for clamping the wire harness on a housing of the lighting module. However, these mounting arrangements may have drawbacks like complex design, an increased number of components leading to increased cost and assembly time. Moreover, these mounting arrangements may have design constrains making them unsuitable for certain locations on the housing. Furthermore, tools might be required to clamp the wire harness in securing such mounting arrangements.

### BRIEF SUMMARY OF THE INVENTION

An object of the present invention is to solve the disadvantages described above of known wire harness clamping systems. In particular, an object of the present invention is to provide a wire harness clamping system for a lighting device.

Another object of the present invention is to provide an “easy to assemble” clamping system for a wire harness.

In this context, the present invention is directed towards a wire harness clamping system. The system comprises a housing, at least one rib provided on the housing and a plug having a cable tie extending from a plug body. The at least one rib is configured to extend to a predefined height from a surface of the housing. The plug body is configured to be secured on the housing by the at least one rib, and the cable tie is configured to secure a wire harness.

In a non-limiting embodiment of the present invention, the at least one rib is configured to form a space to receive the plug body, and includes at least one opening to accommodate at least a portion of the cable tie. In case of single rib configuration, an opening may be provided at a desired location on the rib. In case of two or more ribs configuration, the gap between adjacent ribs may be used as opening. When the plug body of the plug is inserted in the space formed by rib(s), the cable tie passes through the opening thereby restricting rotation of the plug with respect to the ribs.

In a non-limiting embodiment of the present invention, the at least one rib is configured to be integrally formed with the housing.

In a non-limiting embodiment of the present invention, a plurality of ribs are provided on the housing, thereby forming a space to receive the plug body, and an opening is provided between at least two neighboring ribs. Alternatively, an opening may be provided in any one of the ribs as per requirement.

In a non-limiting embodiment of the present invention, the plurality of ribs are configured to be provided in a circular manner, on the housing. Thus, the ribs form a cylindrical space therein for accommodating the plug body.

In a non-limiting embodiment of the present invention, the at least one rib is configured to be made from a flexible material. Any known joining process such as welding etc., may be used to fix the rib(s) on the housing surface.

In a non-limiting embodiment of the present invention, the plug body is configured to be cylindrical.

In a non-limiting embodiment of the present invention, the plug body is configured to have a tapered portion. The plug body may include a cylindrical portion having a predetermined height and tapered portion integrally formed adjacent to the cylindrical portion.

In a non-limiting embodiment of the present invention, the cable tie includes a cable tie head configured to secure the cable tie around the wire harness. The cable tie may be wound around the wire harness and then free end of the cable tie is inserted in the cable tie head and locked therein.

In a non-limiting embodiment of the present invention, the plug is made from a flexible or compressibly pliant material and the cable tie is integrally formed with the plug body.

The present invention also relates to a wire harness clamping system comprising a housing, a plurality of ribs extending from a surface of the housing, and a cap configured to be locked on a portion of said ribs. Said ribs are configured to form a space to accommodate a wire harness. The wire harness is received directly in the space formed by the ribs and secured therein by mounting the cap over the ribs.

In a non-limiting embodiment of the present invention, the cap includes plurality of legs extending from a cap body. The cap body may have geometry complementing to the arrangement of the ribs.

In a non-limiting embodiment of the present invention, the at least one leg of the cap includes a locking profile. The locking profile may be a protrusion with triangular cross-section. Any other suitable locking profile may be formed on the legs of the cap.

In a non-limiting embodiment of the present invention, the at least one rib includes a notch configured to receive the locking profile of the cap. The geometry of the notch may be selected in line with that of the locking profile, such that the notch can receive the locking profile and secure the same.

In a non-limiting embodiment of the present invention, said ribs are configured to be provided in any of a circular, rectangular or S-shaped manner, on the housing. The manner of providing ribs may be determined based on space and design constraints.

In a non-limiting embodiment of the present invention, the cap is configured to be in a shape that corresponds to a shape of said ribs.

In a non-limiting embodiment of the present invention, the cap is configured to lock on said ribs by inserting the locking profile of a number of legs in each corresponding notch thereby clamping the wire harness in the space formed by said ribs.

### BRIEF DESCRIPTION OF THE DRAWINGS

The present invention is expounded in detail below with the aid of the presented drawings. In the drawings:

FIG. 1A illustrates an isometric view of a plurality of ribs provided on a housing, according to an embodiment of present invention;

FIG. 1B illustrates a schematic view of a single rib configuration provided on housing, according to an embodiment of present invention;

FIG. 2A illustrates a schematic view of a plug with cable tie, according to an embodiment of present invention;

FIG. 2B illustrates a schematic view of a wire harness clamping system, according to an embodiment of present invention;

FIG. 3A illustrates a schematic view of a plug having tapered portion, according to an embodiment of present invention;

FIG. 3B illustrates a schematic view of a wire harness clamping system, according to an embodiment of present invention;

FIG. 4A illustrates a schematic view of flexible ribs provided on a housing in an unclamped state of wire harness, according to an embodiment of present invention;

FIG. 4B illustrates a schematic view of a wire harness clamping system, according to an embodiment of present invention;

FIG. 5A illustrates a schematic view of ribs provided on housing, according to an embodiment of present invention;

FIG. 5B illustrates a schematic top view of ribs provided on housing, according to an embodiment of present invention;

FIG. 5C illustrates an isometric view of a cap, according to an embodiment of present invention;

FIG. 5D illustrates a sectional view of a cap, according to an embodiment of present invention;

FIG. 5E illustrates a sectional view of a wire harness clamping system, according to an embodiment of present invention;

FIG. 6A illustrates an isometric view of ribs provided on housing, according to an embodiment of present invention;

FIG. 6B illustrates a schematic top view of ribs provided on housing, according to an embodiment of present invention;

FIG. 6C illustrates an isometric view of a cap, according to an embodiment of present invention;

FIG. 6D illustrates a sectional view of a cap, according to an embodiment of present invention;

FIG. 6E illustrates a sectional view of a wire harness clamping system, according to an embodiment of present invention;

FIG. 7A illustrates an isometric view of ribs provided on housing, according to an embodiment of present invention;

FIG. 7B illustrates a schematic top view of ribs provided on housing, according to an embodiment of present invention;

FIG. 7C illustrates an isometric view of a cap, according to an embodiment of present invention;

FIG. 7D illustrates a sectional view of a cap, according to an embodiment of present invention;

FIG. 7E illustrates a sectional view of a wire harness clamping system, according to an embodiment of present invention; and

FIG. 8 illustrates a schematic view of possible shapes of the ribs, according to an embodiment of present invention.

### DETAILED DESCRIPTION OF THE INVENTION

The characteristics, variants and different modes of realization of the invention may be associated with each other in various combinations, in so far as they are not incompatible or exclusive with each other. In particular, variants of the invention comprising only a selection of features subsequently described in from the other features described may be imagined, if this selection of features is enough to confer a technical advantage and/or to differentiate the invention from prior art.

In the following description, the designations “top” refer to the orientation of the wire harness clamping system as shown in the Figures, however actual orientation of the same may differ based on the orientation of the housing surface in actual lighting device. Further, the expression, “radially outward” corresponds to the direction perpendicular to the axis of the component, along the radius and moving away from the axis.

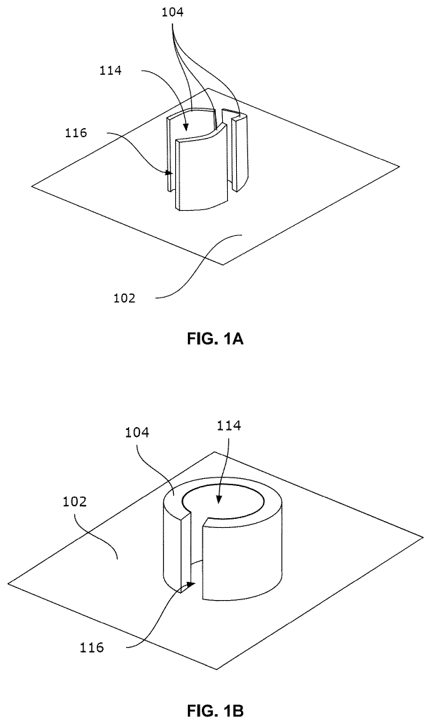

FIG. 1A illustrates a plurality of ribs 104 provided on a surface of a housing 102. The ribs 104 extend from the surface of the housing 102 to a predefined height such that they form a space 114. There may be provided an opening 116 between the neighboring ribs 104. The ribs 104 may be provided on the housing 102 in a circular manner. FIG. 1B illustrates an alternate embodiment with a single rib 104. The single rib 104 may by formed of a hollow cylindrical shape extending from the housing 102 to a predefined height. The single rib 104 forms a space 114 therein and an opening 116 is provided in the rib 104. The opening 116 may be provided throughout the height of the rib 104 or may be partially formed until a predefined distance from the free end of the rib 104.

In an embodiment of the present invention, the rib(s) 104 may be integrally formed with the housing 102. Alternatively, the rib(s) 104 may be connected to the housing 102 by using any suitable joining method such as welding, gluing etc.

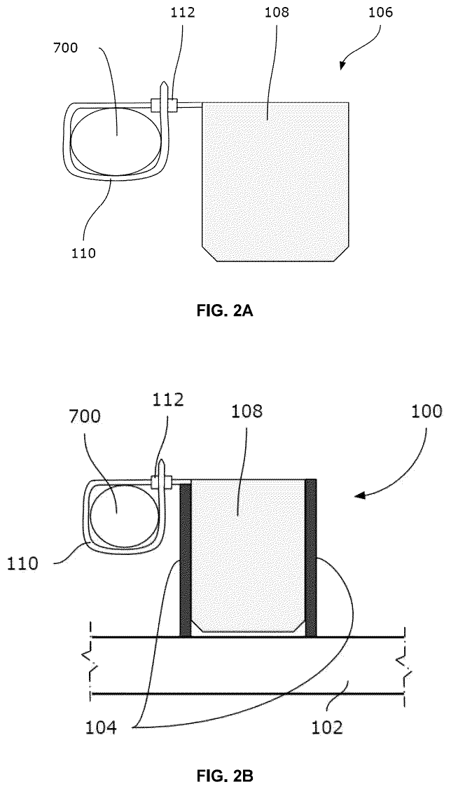

FIG. 2A illustrates a plug 106 according to an embodiment of present invention. The plug 106 comprises a plug body 108 and a cable tie 110 with a cable tie head 112. The plug body 108 may be of a cylindrical shape. The cable tie 110 extends from one end of the plug body 108 in a direction generally perpendicular to the axis of the plug body 108. FIG. 2B illustrates a harness clamping system 100 for mounting a wire harness 700 on the housing 102. The cable tie 110 is wound around the wire harness 700 and the cable tie 110 is secured in the cable tie head 112, thereby firmly securing the wire harness 700. The plug body 108 is inserted in the space 114 formed by the rib(s) 104 on the housing 102, such that the cable tie 110 is received in the opening 116. The plug 106 may be made from any suitable flexible or compressibly pliant material and the cable tie 110 may be integrally formed with the plug body 108. Further, the outer diameter of the plug body 108 is slightly greater than the space 114 such that an interference fit is achieved.

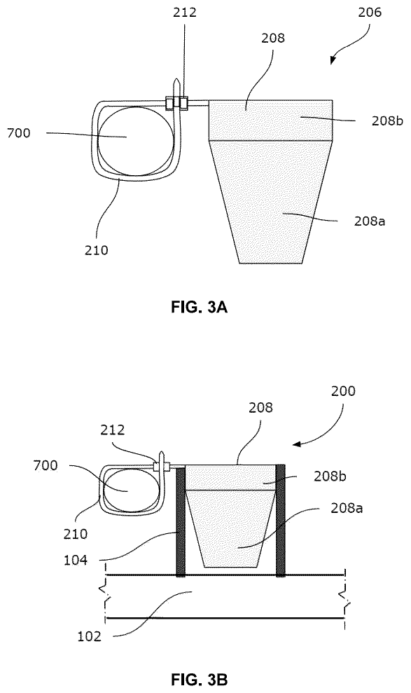

FIG. 3A illustrates an alternate embodiment of the present invention, wherein the plug body 208 of the plug 206 may have a conical/tapered portion 208a formed at one end of a cylindrical portion 208b. The tapered portion 208a facilitates easy insertion of the plug body 208 in the space 114 formed by the rib(s) 104 on the housing 102. The cable tie 210 extends from a cylindrical portion 208b of the plug body 208, in a generally radially outward direction from the axis of the plug body 208. FIG. 3B illustrates a harness clamping system 200 for mounting a wire harness 700 on the housing 102. The wire harness 700 is secured by the cable tie 210 and the plug body 208 is inserted within the space 114 formed by the rib(s) 104 on the housing 102, such that the cable tie 210 is received in the opening 116. Further, the outer diameter of the cylindrical portion 208b of the plug body 208 is slightly greater than that of the space 114 such that an interference fit is provided.

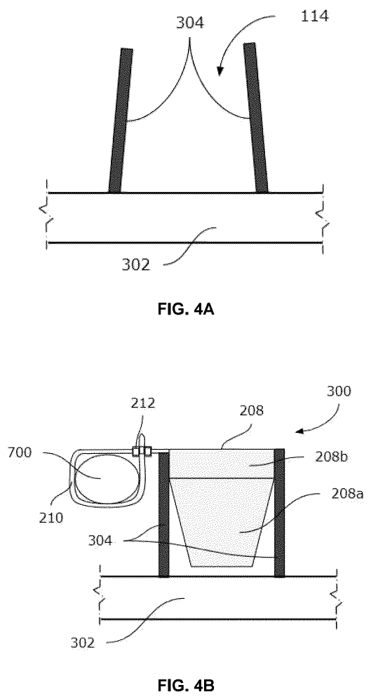

FIG. 4A illustrates an alternate embodiment of the present invention, which comprises of the rib(s) 304 made from a flexible material. Herein, the rib(s) 304 are connected to the housing 302 by any suitable joining process. FIG. 4B illustrates an exemplary embodiment of wire harness clamping system 300 wherein the plug 208 is secured in the space 114 formed by flexible rib(s) 304. Similar to the previous embodiments, the wire harness 700 is firmly gripped by the cable tie 210.

In an embodiment of the present invention, the cable tie 110, 210 may be flexible and may include locking features such as teeth etc. near its free end, to secure the cable tie 110, 210 in the cable tie head 112, 212.

In an embodiment of the present invention, the rib(s) 104, 304 may have constant thickness throughout the height. Alternatively, the thickness of the rib(s) 104, 304 may decrease from the surface of the housing 102, 302 towards the free end of the rib(s) 104, 304, or vice versa.

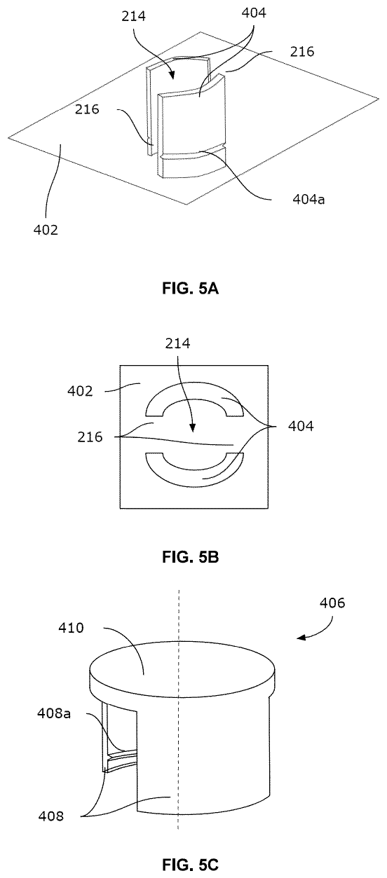

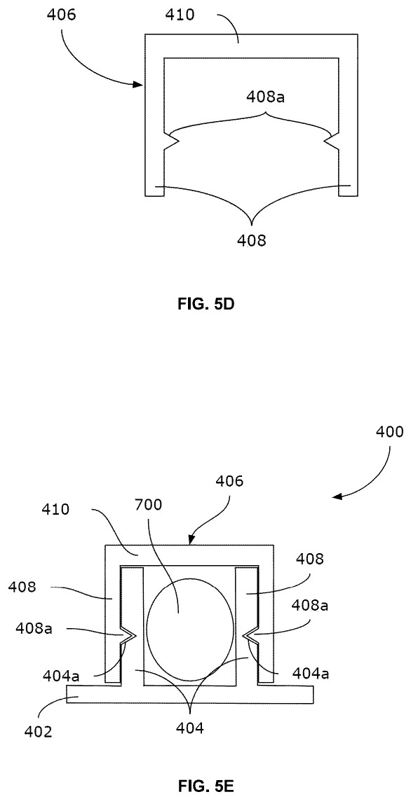

FIGS. 5A-5E illustrate an alternate embodiment of the present invention. Two ribs 404 are provided on a housing 402 such that they extend from the surface of the housing 402 to a predefined height. The ribs 404 form a space 214 therein to accommodate wire harness 700 such that the wire harness 700 passes through the openings 216. As shown in FIG. 5A, a notch 404a may be provided on one or both the ribs 404, at a predefined height from the surface of the housing 402. The notch 404a may be provided on an outer surface of the ribs 404. The ribs 404 may be of curved shape when viewed from top, as shown in FIG. 5B. A cap 406 is illustrated in FIGS. 5C and 5D. The cap 406 comprises a cap body 410 having generally circular shape and at least two legs 408 or a multiple of legs extending from the cap body 410 axially in the same direction. The shape of the legs 408 corresponds to the shape of the ribs 404 such that when the cap 406 is mounted on the ribs 404, the legs 408 are received over the outer surface of the ribs 404 and the cap body 410 sits on free ends of the ribs 404. Further, a locking profile 408a may be provided on or along an inner surface of one or both the legs 408 such that the locking profiles 408a are locked in the notches 404a provided on the ribs 404 when the cap 406 is mounted on the ribs 404. FIG. 5E illustrates the wire harness clamping system 400, wherein the wire harness 700 is positioned in the space 214 formed by the ribs 404 and passes through the openings 216. The cap 406 is mounted over the ribs 404 such that gap between the legs 408 overlaps with the openings 216, and locked therein by securing the locking features 408a in the corresponding notches 404a. Thus, the wire harness 700 is securely clamped on the housing 402.

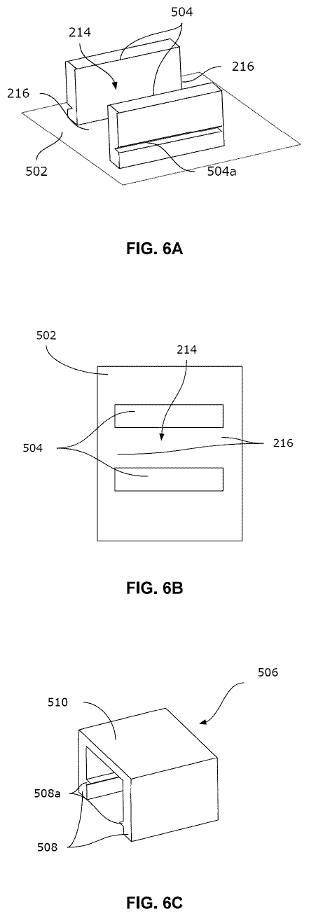

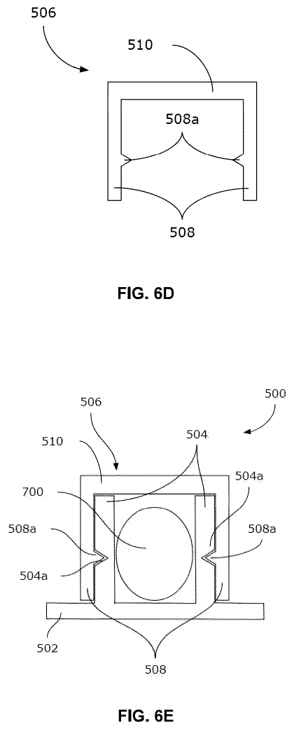

FIGS. 6A-6E illustrate an alternate embodiment of the present invention. Two ribs 504 are provided on a housing 502 such that they extend from the surface of the housing 502 to a predefined height. The ribs 504 form a space 214 therein to accommodate wire harness 700 such that the wire harness 700 passes through the opening spaces 216. As shown in FIG. 6A, a notch 504a may be provided on one or both the ribs 504, at a predefined height from the surface of the housing 502. The notch 504a may be provided on outer surface of the ribs 504. The ribs 504 may be of straight line shape when viewed from top, as shown in FIG. 6B. A cap 506 is illustrated in FIGS. 6C and 6D. The cap 506 comprises a cap body 510 having generally rectangular or square shape, and at least two legs 508 or multiple legs extending from the cap body 510 in the same direction, generally perpendicular to the plane of the cap body 510. The shape of the legs 508 corresponds to the shape of the ribs 504 such that when the cap 506 is mounted on the ribs 504, the legs 508 are received over the outer surface of the ribs 504 and the cap body 510 sits on free ends of the ribs 504. Further, a locking profile 508a may be provided on or along an inner surface of at least one of the legs 508 such that the locking profiles 508a are locked in the notches 504a provided on the ribs 504 when the cap 506 is mounted on the ribs 504. FIG. 6E illustrates the wire harness clamping system 500, wherein the wire harness 700 is positioned in the space 214 formed by the ribs 504 and passes through the openings 216. The cap 506 is mounted over the ribs 504 such that gap between the legs 508 overlaps with the openings 216, and locked therein by securing the locking features 508a in the corresponding notches 504a. Thus, the wire harness 700 is securely clamped on the housing 502.

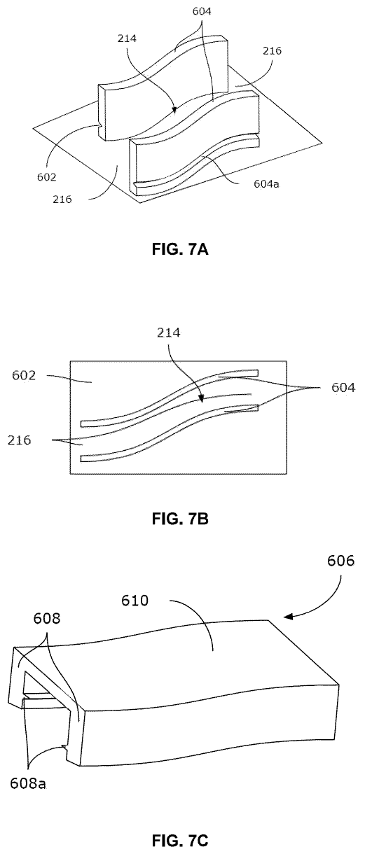

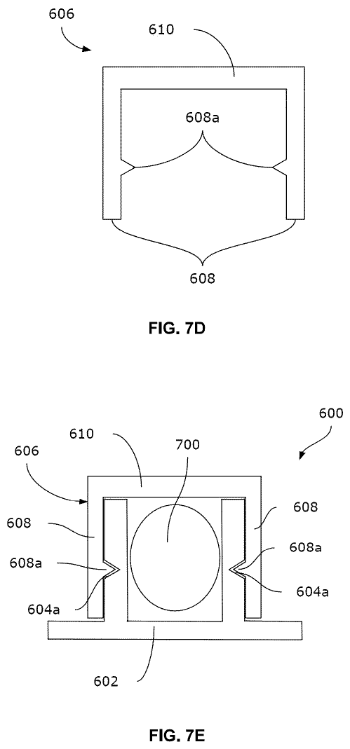

FIGS. 7A-7E illustrate an alternate embodiment of the present invention. Two ribs 604 are provided on a housing 602 such that they extend from the surface of the housing 602 to a predefined height. The ribs 604 form a space 214 therein to accommodate wire harness 700 such that the wire harness 700 passes through the openings 216. As shown in FIG. 7A, a notch 604a may be provided on at least one of the ribs 604, at a predefined height from the surface of the housing 602. The notch 604a may be provided on an outer surface of the ribs 604. The ribs 604 may be formed in S-shape when viewed from top, as shown in FIG. 7B. A cap 606 is illustrated in FIGS. 7C and 7D. The cap 606 comprises a cap body 610 having generally S-shape, and two legs 608 extending from the cap body 610 in the same direction, generally perpendicular to the plane of the cap body 610. The shape of the legs 608 corresponds to the shape of the ribs 604 such that when the cap 606 is mounted on the ribs 604, the legs 608 are received over the outer surface of the ribs 604 and the cap body 610 sits on free ends of the ribs 604. Further, a locking profile 608a may be provided on an inner surface of at least one of the legs 608 such that the locking profiles 608a are locked in the notches 604a provided on the ribs 604 when the cap 606 is mounted on the ribs 604. FIG. 7E illustrates the wire harness clamping system 600, wherein the wire harness 700 is positioned in the space 214 formed by the ribs 604 and passes through the openings 216. The cap 606 is mounted over the ribs 604 such that gap between the legs 608 overlaps with the openings 216, and locked therein by securing the locking features 608a in the corresponding notches 604a. Thus, the wire harness 700 is securely clamped on the housing 602.

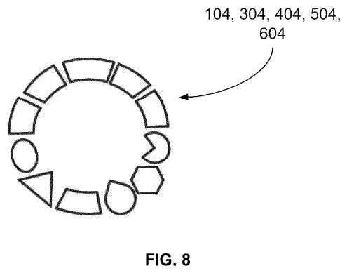

FIG. 8 illustrates the possible shapes that the rib(s) 104, 304, 404, 504, 604 may have, when viewed from top. The rib(s) 104, 304, 404, 504, 604 may be of any shape such as rectangular, oval, hexagonal, triangular, water-drop etc. Furthermore, the number of ribs provided on the housing may be determined based on the design requirements.

The invention shall not, however, be limited to the means and configurations described and illustrated herein, and shall also extend to any equivalent means or configuration described and illustrated herein, and to any technical combination operating such means.

### LIST OF REFERENCE SIGNS

100, 200, 300, 400, 500, 600 Harness clamping system
102, 302, 402, 502, 602 Housing
104, 304, 404, 504, 604 Ribs
106, 206 Plug
108, 208 Plug body
110, 210 Cable tie
112, 212 Cable tie head
114, 214 Space
208a Tapered portion
208b Cylindrical portion
116, 216 Opening
404a, 504a, 604a Notch
406, 506, 606 Cap
408, 508, 608 Legs
408a, 508a, 608a Locking profile
410, 510, 610 Cap body
700 Wire Harness

What is claimed is:

1. A wire harness clamping system comprising:
a housing;
at least one rib provided on the housing, wherein the at least one rib is configured to extend to a predefined height from a surface of the housing; and
a plug having a cable tie extending from a plug body,
wherein the plug body is configured to be secured on the housing by the at least one rib, and the cable tie is configured to secure a wire harness.

2. The system according to claim 1, wherein the at least one rib is configured to form a space to receive the plug body, and includes at least one opening to accommodate at least a portion of the cable tie.

3. The system according to claim 1, wherein the at least one rib is configured to be integrally formed with the housing.

4. The system according to claim 1, wherein a plurality of ribs are provided on the housing, thereby forming a space to receive the plug body, and an opening is provided between at least two adjacent ribs.

5. The system according to claim 4, wherein the plurality of ribs are configured to be provided in a circular manner, on the housing.

6. The system according to claim 1, wherein the at least one rib is configured to be made from a flexible material.

7. The system according to claim 1, wherein the plug body is configured to be cylindrical.

8. The system according to claim 1, wherein the plug body is configured to have a tapered portion.

9. The system according to claim 1, wherein the cable tie includes a cable tie head configured to secure the cable tie around the wire harness.

10. The system according to claim 1, wherein the plug is made from a flexible or compressibly pliant material and the cable tie is integrally formed with the plug body.

11. A wire harness clamping system comprising:
a housing;
a plurality of ribs extending from a surface of the housing; and
a cap configured to be locked on a portion of said ribs,
wherein said ribs are configured to form a space to accommodate a wire harness.

12. The system according to claim 11, wherein the cap includes a plurality of legs extending from a cap body.

13. The system according to claim 12, wherein at least one leg of the cap includes a locking profile.

14. The system according to claim 13, wherein at least one rib includes a notch configured to receive the locking profile of the cap.

15. The system according to claim 11, wherein said ribs are configured to be provided in any of a circular, rectangular or S-shaped manner, on the housing.

16. The system according to claim 15, wherein the cap is configured to be in a shape that corresponds to a shape of said ribs.

17. The system according to claim 13, wherein the cap is configured to lock on said ribs by inserting the locking profile of a number of legs in each corresponding notch thereby clamping the wire harness in the space formed by said ribs.
